(19) United States
(12) Patent Application Publication
(10) Pub. No.: US 2026/0064626 A1
(43) Pub. Date: Mar. 5, 2026

(54) EVENT SIGNALS

(71) Applicant: Siemens Industry Software Inc., Plano, TX (US)

(72) Inventor: Iain Robertson, Cambridge (GB)

(21) Appl. No.: 19/108,327

(22) PCT Filed: Sep. 29, 2022
(86) PCT No.: PCT/US2022/045219

§ 371 Date: Mar. 3, 2025

(51) Int. Cl. G06F 15/78

(52) U.S. Cl. CPC G06F 15/7814

(57) ABSTRACT

A method for an integrated circuit including a plurality of interconnected sub-blocks in a System-on-Chip (SoC) arrangement is provided. The method includes transmitting a message from a first sub-block to at least one sub-block of the plurality of interconnected sub-blocks, in response to an event on the integrated circuit. The method further includes transmitting a signal from the first sub-block to the at least one sub-block of the plurality of interconnected sub-blocks. The signal includes information identifying a class of the event based on a classification of events associated to the integrated circuit into one or more classes.

The present patent document is a § 371 nationalization of PCT Application Serial No. PCT/EP2022/045219, filed Sep. 29, 2022, designating the United States, which is hereby incorporated by reference in its entirety.

### TECHNICAL FIELD

The present disclosure relates to methods and systems for an integrated circuit. In particular, the methods relate to integrated circuits including sub-blocks in a System-on-Chip (SoC) arrangement.

### BACKGROUND

In recent years, electronic devices incorporating System-on-Chip (SoC) circuits have become ubiquitous. This trend has been driven by demand for small consumer electronics devices such as smart phones and tablets and the use of SoC in embedded systems such as Internet-of-Things (IoT) devices and Wi-Fi routers.

SoC devices are integrated circuits that combine computing components on a single substrate or microchip. These components may include one or more processor cores, memory, input/output interfaces, a graphics processing unit (GPU), and secondary storage interfaces. SoC architectures provide numerous benefits including power saving, space saving, lower latency, and cost reduction.

### SUMMARY

It is an object of the disclosure to provide a method for an integrated circuit.

The foregoing and other objects are achieved by the features of the independent claims. Further implementation forms are apparent from the dependent claims, the description and the figures.

According to a first aspect, a method for an integrated circuit including a plurality of interconnected sub-blocks in a System-on-Chip (SoC) arrangement is provided. The method includes transmitting a message from a first sub-block to at least one sub-block of the plurality of interconnected sub-blocks in response to an event on the integrated circuit. The method further includes transmitting a signal from the first sub-block to the at least one sub-block of the plurality of interconnected sub-blocks. The signal includes information identifying a class of the event based on a classification of events associated to the integrated circuit into one or more classes.

The method according to the first aspect enables a receiving sub-block of the integrated circuit to identify a class of an event based on a signal received with an event message.

According to a second aspect, a method for an integrated circuit including at least two interconnected sub-blocks in a System-on-Chip (SoC) arrangement is provided. The method includes transmitting, from a first sub-block to a second sub-block, a first signal asserting that the first sub-block is ready to transmit data to the second sub-block. The method further includes receiving, from the second sub-block, at the first sub-block, a second signal that asserts that the second sub-block is ready to receive data from the first sub-block. The method further includes transmitting data via a third signal from the first sub-block to the second sub-block. In response to an event on the integrated circuit, the first sub-block is configured to transmit a message to the second sub-block. The first signal includes information identifying a class of the event based on a classification of events associated to the integrated circuit into one or more classes.

According to a third aspect, an integrated circuit including a plurality of interconnected sub-blocks in a System-on-Chip (SoC) arrangement is provided. At least a first sub-block of the plurality of sub-blocks is configured to transmit a message to at least one sub-block of the plurality of interconnected sub-blocks, in response to an event on the integrated circuit and transmit a signal to the at least one sub-block of the plurality of interconnected sub-blocks. The signal includes information identifying a class of the event based on a classification of events associated to the integrated circuit into one or more classes.

According to a fourth aspect, an integrated circuit including at least two interconnected sub-blocks in a System-on-Chip (SoC) arrangement is provided. A first sub-block of the integrated circuit is configured to transmit a first signal asserting that the first sub-block is ready to transmit data to a second sub-block, receive, from the second sub-block, a second signal that asserts that the second sub-block is ready to receive data from the first sub-block and transmit data via a third signal to the second sub-block. In response to an event on the integrated circuit, the first sub-block is configured to transmit a message to the second sub-block. The first signal includes information identifying a class of the event based on a classification of events associated to the integrated circuit into one or more classes.

In a first implementation of the method according to the first aspect, the event is a local event in a subsystem of one or more sub-blocks in the integrated circuit.

In a second implementation, transmitting the message and signal to at least one sub-block of the plurality of interconnected sub-blocks includes transmitting the message and signal to every sub-block in the subsystem.

The method according to the first and second implementations provide localized event notification to every sub-block in a subsystem of an integrated circuit with low latency.

In a third implementation, the event is a global event.

In a fourth implementation, transmitting the message and signal to at least one sub-block of the plurality of interconnected sub-blocks includes transmitting the message and signal to every sub-block in the integrated circuit.

The method according to the third and fourth implementations provide global event notification to every sub-block in an integrated circuit with low latency.

In a fifth implementation, the information identifying the class of the event includes an encoding of the class of the event in one or more data bits for transmission in the signal.

In a sixth implementation, the signal is a signal in a communication protocol between the first sub-block and the at least one sub-block of the plurality of interconnected sub-blocks.

These and other aspects of the disclosure are apparent from the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings.

FIG. 1 depicts a schematic diagram of an integrated circuit, according to an example.

FIG. 2 depicts a block diagram of a method for an integrated circuit, according to an example.

FIG. 3 depicts a block diagram of a method for an integrated circuit, according to an example.

FIG. 4 depicts a signal diagram, according to an example.

### DETAILED DESCRIPTION

Example embodiments are described below in sufficient detail to enable those of ordinary skill in the art to embody and implement the systems and processes herein described. It is important to understand that embodiments may be provided in many alternate forms and may not be construed as limited to the examples set forth herein.

Accordingly, while embodiments may be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims may be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document may not preclude the presence of more than one referent. In other words, elements referred to in the singular may number one or more, unless the context clearly indicates otherwise. The terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms including technical and scientific terms used herein are to be interpreted as is customary in the art. Terms in common usage may also be interpreted as is customary in the relevant art and not in an idealized or overly formal sense unless expressly so defined herein.

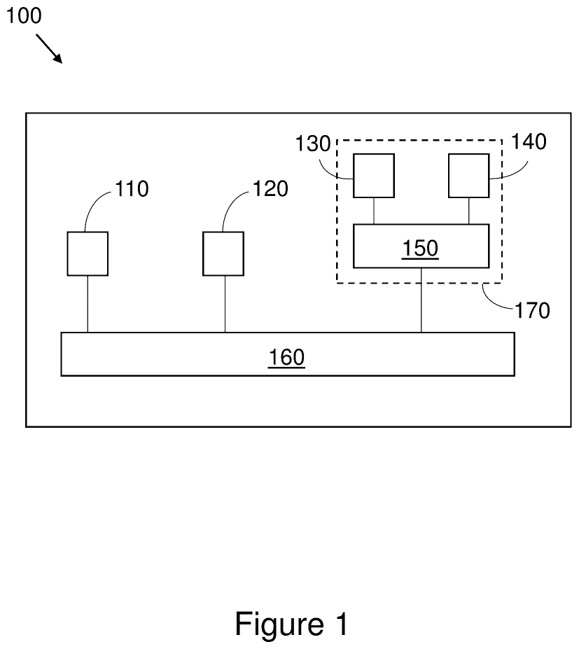

FIG. 1 is a simplified schematic diagram showing an integrated circuit 100, according to an example. The integrated circuit 100 shown in FIG. 1 may be used in conjunction with the other methods and systems described herein.

The integrated circuit 100 includes sub-blocks 110, 120, 130, 140 in a System on Chip (SoC) arrangement. The sub-blocks 110, 120, 130, 140 are fully integrated into the circuit 100 on a single substrate or microchip. Each sub-block of sub-blocks 110, 120, 130, 140 may be a central processing unit (CPU), a memory device, input/output device, secondary storage devices, graphical processing units (GPUs), custom logic or any other type of component suitable for a SoC architecture. In some examples, the integrated circuit 100 may include more or fewer sub-blocks.

In FIG. 1, the sub-blocks 110, 120, 130, 140 are configured to communicate data messages via a messaging infrastructure. The messaging infrastructure includes interconnect circuitry and message engines 150, 160. The message engines 150, 160 are sub-blocks that are configured to perform routing of data messages to other parts of the integrated circuit 100. In particular, the message engines 150, 160 are configured to implement protocols to enable transmission of data messages through the integrated circuit. Data messages may be transmitted between sub-blocks for different purposes. For example, messages may be transmitted for system configuration and control, data capture and communication.

The messaging infrastructure in the integrated circuit 100 also supports a further kind of message referred to as an event message. Event messages are messages that are communicated from sub-blocks in real-time in response to events on the integrated circuit 100. For example, an event message may be output by a sub-block in response to detecting that data has been written to a certain address in memory. Event messages may be broadcast to some or all of the sub-blocks in the integrated circuit 100. In response to receiving an event message, a sub-block may perform further actions. For example, an event message may cause a sub-block to halt an operation or process or perform a further process such as data capture or monitoring.

Events may be classified into one or more classes. For example, events may be ‘global’ or ‘local’ events. A global event is an event that causes a sub-block to transmit an event message for the event to every sub-block on the integrated circuit 100. A local event is an event that causes a sub-block in a subsystem of the integrated circuit to transmit an event message to every sub-block in the same sub-system. For example, in FIG. 1, sub-blocks 130, 140 and message engine 160 form a sub-system 170 of the integrated circuit 100. The sub-block 130 may transmit a local event message to sub-block 140 in response to a local event in the sub-block 130. The sub-block 130 may transmit a global event message to sub-blocks 110, 120, 140 in response to a global event.

Events and event messages may be user-configurable. In some cases, a class of event messages may also be non-configurable for users. These event messages may be reserved, for example, for events defined by the manufacturer of the integrated circuit.

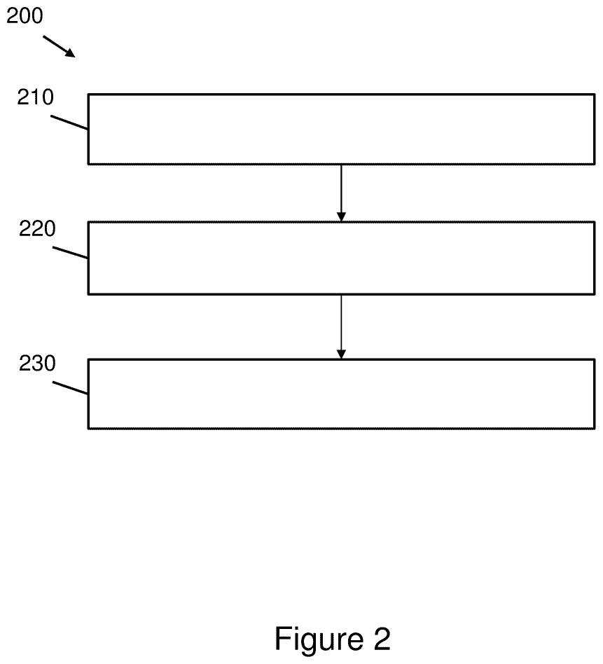

FIG. 2 is a block diagram of a method 200 for an integrated circuit including a plurality of interconnected sub-blocks in a SoC arrangement, according to an example. The method 200 may be used in conjunction with the integrated circuit 100.

At block 210, the method 200 includes transmitting a message from a first sub-block to at least one sub-block of the plurality of interconnected sub-blocks in response to an event on the integrated circuit. As previously described, events may be classified as ‘local’ or ‘global’ events and, in some cases, ‘private’ events. When the event is a local event, transmitting the message includes transmitting the message to every sub-block in the subsystem of the integrated circuit in which the local event occurred. In contrast, when the event is a global event, transmitting the message includes transmitting the message to every sub-block in the integrated circuit.

At block 220, the method 200 includes transmitting a signal from the first sub-block to the at least one sub-block of the plurality of interconnected sub-blocks. The signal includes information identifying a class of the event based on a classification of events associated to the integrated circuit into one or more classes. In other words, the signal includes information that may be used to determine the class of event that triggered the event message. The information identifying the class of the event may include an encoding of the class of the event in one or more data bits for transmission in the signal. The signal enables a receiving sub-block to determine the class of event and process the event message accordingly.

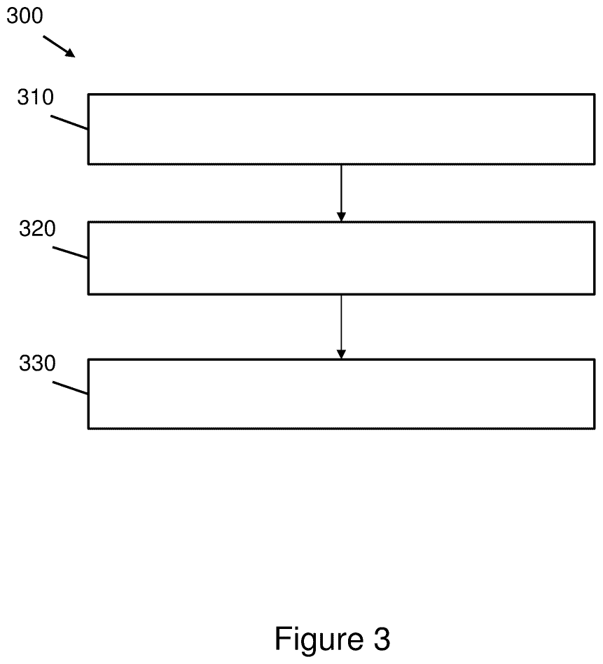

In some cases, the signal may be a signal used in a communication protocol between the sub-blocks 110, 120, 130, 140 and the message engines 150, 160. FIG. 3 is a block diagram of a method 300 for an integrated circuit such as the integrated circuit 100 shown in FIG. 1. The method 300 incorporates the signal previously described in a communication protocol.

At block 310, the method includes transmitting, from a first sub-block to a second sub-block, a first signal asserting that the first sub-block is ready to transmit data to the second sub-block. For example, during a ‘normal’ transmission of data messages the sub-block 110 may communicate a first signal indicating that the sub-block is ready to transmit data to the message engine 160.

At block 320, the method 300 includes receiving a second signal from the second sub-block at the first sub-block, the second signal asserting that the second sub-block is ready to receive data from the first sub-block. For example, the message engine 160 may communicate the second signal indicating that the message engine 160 is ready to receive data from the sub-block 110.

At block 330, the method 300 includes transmitting data via a third signal from the first sub-block to the second sub-block. For example, in response to the second signal from the message engine 160, the sub-block 110 may transmit data including one or more data messages to the message engine 160.

When an event occurs at the first sub-block in the method 300, the sub-block may respond by communicating an event message. The first signal, which was initially used to communicate that the first sub-block was ready to transmit data, is instead used to communicate information identifying a class of the event based on a classification of events associated to the integrated circuit into one or more classes. The first signal may also be used communicate information relating to the data messages such as the position of an endpoint of a message.

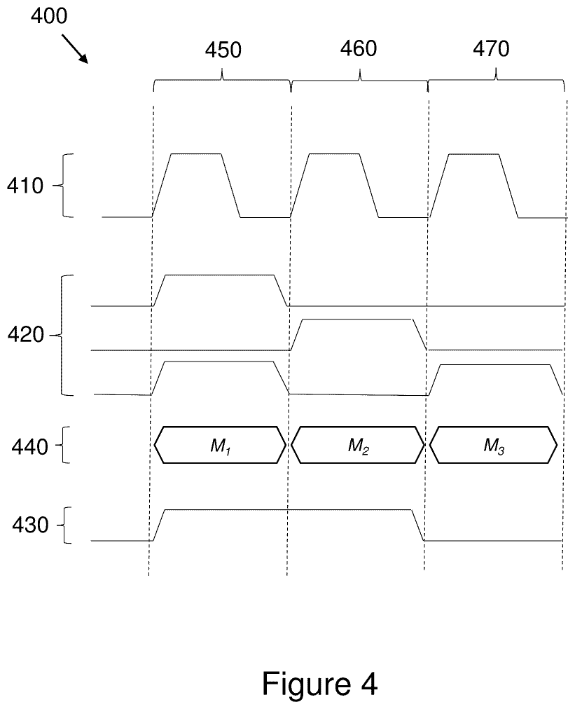

FIG. 4 shows a signal diagram 400. The signal diagram 400 includes a clock signal 410 and signals 420, 430, 440. These signals correspond to the first, second, and third signals of the method 300. The clock signal 410 includes three clock cycles 450, 460, 470. This clock signal may correspond to the clock signal of the integrated circuit 100, for example. In FIG. 4, the signal 420, which corresponds to the first signal in the method 300 is represented as three separate signals, which each have 0/1 states representing three bits of information. The signal 430 has 0/1 states, which corresponds to the signal sent from the second sub-block to the first sub-block in the method 300, indicating when the second sub-block is ready to receive data from the first sub-block. The signal 440 corresponds to the third signal that transmits data from the first sub-block to the second sub-block.

In FIG. 4, initially all the signals are in the 0 state. In the first clock cycle 450, the signal 430 transmits a ‘1’ meaning that the second sub-block is ready to receive data from the first sub-block. The signal 440 transmits a data message M₁ follow by a local event message M₂ followed by a global event M₃. The signal 420 transmits data bits 101 in the first clock cycle 450. This means that the first message M₁ is a data message, the beat contains the end of the message and only one message was sent. In the second clock cycle 460, the signal 420 transmits data bits 010 meaning that the message M₂ is an event message, and the event is a local event. In the third clock cycle 470, the signal 420 transmits data bits 001 meaning that the message M₃ is an event message, and the event is a global event.

In the third clock cycle 470, the signal 430 is in the ‘0’ state. This signal corresponds to the signal sent from the second sub-block to the first sub-block in the method 300. The signal 430 being in the ‘0’ state indicates that the second sub-block is indicating to the first sub-block that it is not ready to receive data. However, since the message M₃ is an event message and not a data message, the message will still be broadcast to the second sub-block irrespective of whether the second sub-block explicitly indicates it is ready to receive to data to the first sub-block.

The present disclosure is described with reference to flow charts and/or block diagrams of the method, devices, and systems according to examples of the present disclosure. Although the flow diagrams described above show a specific order of execution, the order of execution may differ from what is depicted. Blocks described in relation to one flow chart may be combined with those of another flow chart. In some examples, some blocks of the flow diagrams may not be necessary and/or additional blocks may be added.

The present disclosure may be embodied in other specific apparatus and/or methods. The described embodiments are to be considered in all respects as illustrative and not restrictive. In particular, the scope of the disclosure is indicated by the appended claims rather than by the description and figures herein. All changes that come within the meaning and range of equivalency of the claims are to be embraced within their scope.

1. A method for an integrated circuit comprising a plurality of interconnected sub-blocks in a System-on-Chip (SoC) arrangement, the method comprising:
transmitting a message from a first sub-block to at least one sub-block of the plurality of interconnected sub-blocks, in response to an event on the integrated circuit; and
transmitting a signal from the first sub-block to the at least one sub-block of the plurality of interconnected sub-blocks,
wherein the signal comprises information identifying a class of the event based on a classification of events associated to the integrated circuit into one or more classes.

2. The method of claim 1, wherein the event is a local event in a subsystem of one or more sub-blocks of the plurality of interconnected sub-blocks in the integrated circuit.

3. The method of claim 2, wherein the transmitting of the message and the transmitting of the signal to the at least one sub-block of the plurality of interconnected sub-blocks comprises transmitting the message and transmitting the signal to every sub-block of the plurality of interconnected sub-blocks in the subsystem.

4. The method of claim 1, wherein the event is a global event.

5. The method of claim 4, wherein the transmitting of the message and the transmitting of the signal to the at least one sub-block of the plurality of interconnected sub-blocks comprises transmitting the message and transmitting the signal to every sub-block of the plurality of interconnected sub-blocks in the integrated circuit.

6. The method of claim 1, wherein the information identifying the class of the event comprises an encoding of the class of the event in one or more data bits for transmission in the signal.

7. The method of claim 1, wherein the signal is a signal in a communication protocol between the first sub-block and the at least one sub-block of the plurality of interconnected sub-blocks.

8. A method for an integrated circuit comprising at least two interconnected sub-blocks in a System-on-Chip (SoC) arrangement, the method comprising:
transmitting, from a first sub-block to a second sub-block of the at least two interconnected sub-blocks, a first signal asserting that the first sub-block is ready to transmit data to the second sub-block;
receiving, at the first sub-block from the second sub-block, a second signal, the second signal asserting that the second sub-block is ready to receive data from the first sub-block; and
transmitting data via a third signal from the first sub-block to the second sub-block,
wherein, in response to an event on the integrated circuit, the first sub-block is configured to transmit a message to the second sub-block, and
wherein the first signal comprises information identifying a class of the event based on a classification of events associated to the integrated circuit into one or more classes.

9. An integrated circuit comprising a plurality of interconnected sub-blocks in a System-on-Chip (SoC) arrangement, wherein at least a first sub-block of the plurality of interconnected sub-blocks is configured to:
transmit a message to at least one sub-block of the plurality of interconnected sub-blocks, in response to an event on the integrated circuit; and
transmit a signal to the at least one sub-block of the plurality of interconnected sub-blocks,
wherein the signal comprises information identifying a class of the event based on a classification of events associated to the integrated circuit into one or more classes.

10. The integrated circuit of claim 9, wherein the event is a local event in a subsystem of one or more sub-blocks of the plurality of interconnected sub-blocks in the integrated circuit.

11. The integrated circuit of claim 10, wherein the first sub-block is configured to transmit the message and transmit the signal to every sub-block of the plurality of interconnected sub-blocks in the subsystem.

12. The integrated circuit of claim 9, wherein the event is a global event.

13. The integrated circuit of claim 12, wherein the first sub-block is configured to transmit the message and transmit the signal to every sub-block of the plurality of interconnected sub-blocks in the integrated circuit.

14. The integrated circuit of claim 9, wherein the information identifying the class of the event comprises an encoding of the class of the event in one or more data bits for transmission in the signal.

15. An integrated circuit comprising at least two interconnected sub-blocks in a System-on-Chip (SoC) arrangement, wherein a first sub-block of the integrated circuit is configured to:
transmit a first signal asserting that the first sub-block is ready to transmit data to a second sub-block of the at least two interconnected sub-blocks;
receive, from the second sub-block, a second signal, the second signal asserting that the second sub-block is ready to receive data from the first sub-block; and
transmit data via a third signal to the second sub-block,
wherein, in response to an event on the integrated circuit, the first sub-block is configured to transmit a message to the second sub-block; and
wherein the first signal comprises information identifying a class of the event based on a classification of events associated to the integrated circuit into one or more classes.
